(19) United States
(12) Patent Application Publication
(10) Pub. No.: US 2008/0211816 A1
(43) Pub. Date: Sep. 4, 2008

(54) Multiple parallel processor computer graphics system

(75) Inventors: Nelson Gonzalez, Miami, FL (US); Humberto Organvidez, Miami, FL (US); Juan H. Organvidez, Miami, FL (US)

Correspondence Address: HOGAN & HARTSON LLP;IP GROUP, COLUMBIA SQUARE, 555 THIRTEENTH STREET, N.W., WASHINGTON, DC, 20004, US

(73) Assignee: Alienware Labs. Corp.

(21) Appl. No.: 11/522,525

(22) Filed: Sep. 18, 2006

Related U.S. Application Data
(63) Continuation-in-part of application No. 10/620,150, filed on Jul. 15, 2003, now Pat. No. 7,119,808.

(51) Int. Cl. G06F 15/80; G06F 15/16

(52) U.S. Cl. 345/505; 345/502

(57) ABSTRACT

An accelerated graphics processing subsystem combines the processing power of multiple graphics processing units (GPUs) or video cards. Video processing by the multiple video cards is organized by time division such that each video card is responsible for video data processing during a different time period. For example, two video cards may take turns, with the first video card controlling a display for a certain time period and the second video sequentially assuming video processing duties for a subsequent period. In this way, as one video card is managing the display in one time period, the second video card is processing video data for the for the next time period, thereby allowing extensive processing of the video data before the start of the next time period. The present invention may further incorporate load balancing such that the duration of the processing time periods for each of the video cards is dynamically modified to maximize composite video processing.

### CROSS REFERENCE TO RELATED APPLICATIONS

The present application is a continuation-in-part of U.S. non-provisional application Ser. No. 10/620,150, filed Jul. 15, 2003, the subject matter of which is hereby incorporated by reference in full.

### STATEMENT REGARDING SPONSORED RESEARCH OR DEVELOPMENT

Not Applicable.

### REFERENCE TO SEQUENCE LISTING

Not Applicable.

### BACKGROUND OF THE INVENTION

1. Field of the Invention

The present invention relates to the processing of graphics instructions in computers. Specifically, the preferred embodiment of the present invention discloses an accelerated graphics processing subsystem for use in computers that utilizes multiple, off-the-shelf, video cards, each one having its one or more graphic processor units (GPUs), and assigns each video card to alternately generate instructions for drawing a display. The video cards to be used in the disclosed invention need not be modified in any substantial way

2. Description of Related Art

Even before the beginning of the widespread use of personal computers, computer graphics has been one of the most promising, and most challenging, aspects of computing. The first graphics personal computers developed for mass markets relied on the main computer processing unit (CPU) to control every aspect of graphics output. Graphics boards, or video cards, in early systems acted as simple interfaces between the CPU and the display device, and did not conduct any processing of their own. In other words, these early video cards simply translated low level hardware commands issued by the CPU into analog signals which the display devices transformed into on-screen images. Because all of the processing was conducted by the CPU, graphics-intensive applications had a tendency to over-utilize processing cycles and prevent the CPU from performing other duties. This led to overall sluggishness and degraded system performance.

To offload the graphics workload from the CPU, hardware developers introduced graphics processing subsystems to render realistic animated images in real time, e.g., at 30 or more frames per second. These subsystems are most often implemented on expansion cards that can be inserted into appropriately configured slots on a motherboard of a computer system and generally include one or more dedicated graphics processing units (GPUs) and dedicated graphics memory. GPUs are capable of accepting high level graphics commands and processing them internally into the video signals required by display devices. The typical GPU is a highly complex integrated circuit device optimized to perform graphics computations (e.g., matrix transformations, scan-conversion and/or other rasterization techniques, texture blending, etc.) and write the results to the graphics memory. The GPU is a “slave” processor that operates in response to commands received from a driver program executing on a “master” processor, generally the central processing unit (CPU) of the system. By way of an extremely simplistic example, if an application requires a triangle to be drawn on the screen, rather than requiring the CPU to instruct the video card where to draw individual pixels on the screen (i.e., low level hardware commands), the application could simply send a “draw triangle” command to the video card, along with certain parameters (such the location of the triangle's vertices), and the GPU could process such high level commands into a video signal. In this fashion, graphics processing previously performed by the CPU is now performed by the GPU. This innovation allows the CPU to handle non-graphics related duties more efficiently.

The primary drawback with early GPU-based video cards was that there was no set standard for the “language” of the various high level commands that the GPUs could interpret and then process. As a result, every application that sought to utilize the high level functions of a GPU-based video card required a specialized piece of software, commonly referred to as a driver, which could understand the GPU's language. With hundreds of different GPU-based video cards on the market, application developers became bogged down in writing these specialized drivers. In fact, it was not uncommon for a particularly popular software program to include hundreds, if not thousands, of video card drivers with its executable code. This greatly slowed the development and adoption of new software.

This language problem was resolved by the adoption, in modern computer operating systems, of standard methods of video card interfacing. Modern operating systems, such as the Windows® operating system (sold by Microsoft Corporation of Redmond, Wash.), require only a single hardware driver to be written for a video card. Interaction between the various software applications, the CPU and the video card is mediated by an intermediate software layer termed an Application Programming Interface (API or API module). All that is required is that the video drivers and the applications be able to interpret a common graphics API. The two most common graphics APIs in use in today's personal computers are DirectX®, distributed by Microsoft Corporation of Redmond, Wash., and OpenGL®, distributed by a consortium of computer hardware and software interests.

Since the advent of the GPU-based graphics processing subsystem, most efforts to increase the throughput of personal computer graphics subsystems (i.e., make the subsystem process information faster) have been geared, quite naturally, toward producing more powerful and complex GPUs, and optimizing and increasing the capabilities of their corresponding APIs.

Another way in which hardware developers have sought to increase the graphics subsystem throughput is by using multiple GPUs on a single video card to process graphics information in parallel. Parallel operation substantially increases the number of rendering operations that can be carried out per second without requiring significant advances in GPU design. To minimize resource conflicts between the GPUs, each GPU is generally provided with its own dedicated memory area, including a display buffer to which the GPU writes pixel data it renders. An example, it is known to process video command signals from APIs such as DirectX or OpenGL using multiple GPUs. One GPU is designated as a primary GPU and the other as a secondary GPU. Although both GPUs independently process graphics commands that derive from an API, the secondary GPU must still route the information it processes (i.e., the digital representation for the portion of the screen assigned to it) through the primary GPU which, in turn, transfers a single, combined output video signal to the video display device. One obvious and significant drawback with this system is that a high bandwidth pipeline must exist between the two GPUs.

No known devices, systems or methods provide a graphics processing subsystem for use in a computer that combines the processing power of multiple, off-the-shelf video cards, each one having one or more GPUs, and assigns each video card to process instructions for drawing a predetermined portion of the screen which is displayed to the user through a monitor or other visual output device. In addition, none of the above devices describes a graphics processing subsystem capable of combining multiple, off-the-shelf video cards without substantial modification to the video cards.

Therefore, there is a need in the prior art for a graphics processing subsystem for use in a computer that combines the processing power of multiple video cards, each one having one or more GPUs, and assigns each video card to process instructions for drawing a predetermined portion of the screen which is displayed to the user through a monitor or other visual output device.

There is a further need in the prior art for a graphics processing subsystem capable of combining multiple, off-the-shelf video cards without substantial modification to the video cards. There is a further need in the prior art for a graphics processing subsystem that can combine the processing power of multiple video cards and which does not require a high bandwidth connection between the video cards.

### BRIEF SUMMARY OF THE INVENTION

The subject invention resolves the above described needs and problems by providing a graphics processing subsystem for use in a computer that combines the processing power of multiple, off-the-shelf video cards without substantial modification, with each video card having one or more GPUs, and assigns each video card to process instructions for drawing a predetermined portion of the screen which is displayed to the user through a monitor or other visual output device such as a cathode ray tube display, a liquid crystal display, a plasma screen display, a projection display, an OLED display, a head-mounted displays, or a hybrid thereof.

The basic components of the present invention are: (1) a software Graphics Command Replicator (GCR) module; (2) multiple video cards each equipped with at least one GPU; (3) a mechanism to ensure that the video signal outputs of the multiple video cards are synchronized; and (4) a Video Merger Hub (“VMH”) hardware/software component.

In general terms, the present invention operates by intercepting the graphics commands issued by a computer application and replicating those commands through the GCR module into multiple graphic command streams. The number of command streams corresponds to the number of video cards present in the system. Each graphic command stream generated by the GCR module directs each video card to generate an image only for a particular portion of the screen. The multiple video cards are synchronized to the same video frame through one of a number of available mechanisms well known to those skilled in the art. The resulting video signals from the multiple video cards are then collected at the VMH and assembled into a complete screen which is then displayed by a monitor or other video output device.

It will be observed by those skilled in the art and through experimentation that by utilizing multiple video cards, each processing only a portion of the screen, that the total throughput of the graphics subsystem is increased in proportion to the number of video cards. The throughput increase, however, is not infinitely extendible as the GCR module introduces at least minimal amounts of processing overhead which also increases in proportion to the number of video cards.

Accordingly, in one embodiment, the present invention consists of an accelerated graphics processing subsystem comprising a graphics command replicator (CGR) consisting of a software module that intercepts graphics commands issued by an application and generates multiple, modified graphics command streams; a plurality of video cards, each equipped with one or more GPUs, wherein the number of the multiple, modified graphics command streams is equal to the number of the plurality of video cards; a mechanism to synchronize the signal output by the plurality of video cards; and a video merger hub comprised of a video switch, a video switch controller, a microcontroller and a video output; wherein the graphics command replicator (GCR) generates the multiple, modified graphics command streams such that each of the multiple, modified graphics command streams contains commands to draw only a portion of a graphics screen; each of the multiple, modified graphics command streams is received by a separate video card selected from the plurality of video cards; output signals from the plurality of video cards are received by the video switch and selected portions thereof are sequentially routed to the video output and displayed on a visual output device; and the video switch is controlled by the video switch controller through the triggering of routing switches at appropriate intervals determined by the vertical refresh rate and vertical resolution of the output signals from the plurality of video cards and by the load balancing ratio assigned to each card in the plurality of video cards.

Also disclosed is a method for accelerating the processing of graphics instructions on a computer through the use of a plurality of video cards, comprising the steps of: intercepting graphics commands issued by an application and generating multiple, modified graphics command streams wherein the number of the multiple, modified graphics command streams is equal to the number of the plurality of video cards; synchronizing the signal output by the plurality of video cards; combining the output signal from the plurality of video cards into a single graphics output signal through use of a video merger hub comprised of a video switch, a video switch controller, a microcontroller and a video output; and displaying the single graphics output signal on a visual output device; wherein each of the multiple, modified graphics command streams contains commands to draw only a portion of a graphics screen; each of the multiple, modified graphics command streams is received by a separate video card selected from the plurality of video cards; output signals from the plurality of video cards are received by the video switch and selected portions thereof are sequentially routed to the video output and displayed on a visual output device; and the video switch is controlled by the video switch controller through the triggering of routing switches at appropriate intervals determined by the vertical refresh rate and vertical resolution of the output signals from the plurality of video cards and by the load balancing ratio assigned to each card in the plurality of video cards.

Therefore, embodiments of the present invention provide an accelerated graphics processing subsystem for use in computers that combines the processing power of multiple video cards, each one having one or more GPUs, and assigns each video card to process instructions for drawing a predetermined portion of the screen which is displayed to the user through a monitor or other visual output device. Embodiments of the present invention provide a graphics processing subsystem capable of accelerating video graphics output by combining multiple, off-the-shelf video cards without substantial modification. Other embodiments of present invention provide a graphics processing subsystem which does not require a high bandwidth connection between the video cards.

In another embodiment, the present invention organizes video processing by multiple video cards (or GPUs) such that each of the video cards is responsible for the video processing during different time periods. For example, two video cards may cooperate to provide video data to a display by taking turns, with the first video card controlling the display for a certain time period and the second video sequentially assuming video processing duties for a subsequent period. This configuration provides the advantage that while one video card is providing processed video data, the second video card is performing its processing of the next video data for the next time period, thereby minimizing delays since processing of the video data may be completed before the start of the next time period.

### BRIEF DESCRIPTION OF THE SEVERAL VIEWS OF THE DRAWINGS

These and other aspects, features and advantages of the present invention may be more clearly understood and appreciated from a review of ensuing detailed description of the preferred and alternate embodiments and by reference to the accompanying drawings and claims.

FIG. 1 shows a block diagram of a typical (prior art), single video card graphics subsystem.

FIGS. 2 and 6 show a block diagram of the multi-video card graphics subsystem of embodiments of the present invention.

FIG. 3 shows an illustration of the application of the multiple command streams generated by the Graphics Command Replicator of the present invention.

FIGS. 4-5 and 7-8 show a schematic representation of the operation of a Video Merger Hub of embodiments of the present invention.

### DETAILED DESCRIPTION OF THE INVENTION

While the present invention will be described more fully hereinafter with reference to the accompanying drawings, in which a preferred embodiment of the present invention is shown, it is to be understood at the outset of the description which follows that persons of skill in the appropriate arts may modify the invention herein described while still achieving the favorable results of this invention. Accordingly, the description which follows is to be understood as being a broad, teaching disclosure directed to persons of skill in the appropriate arts, and not as limiting upon the present invention.

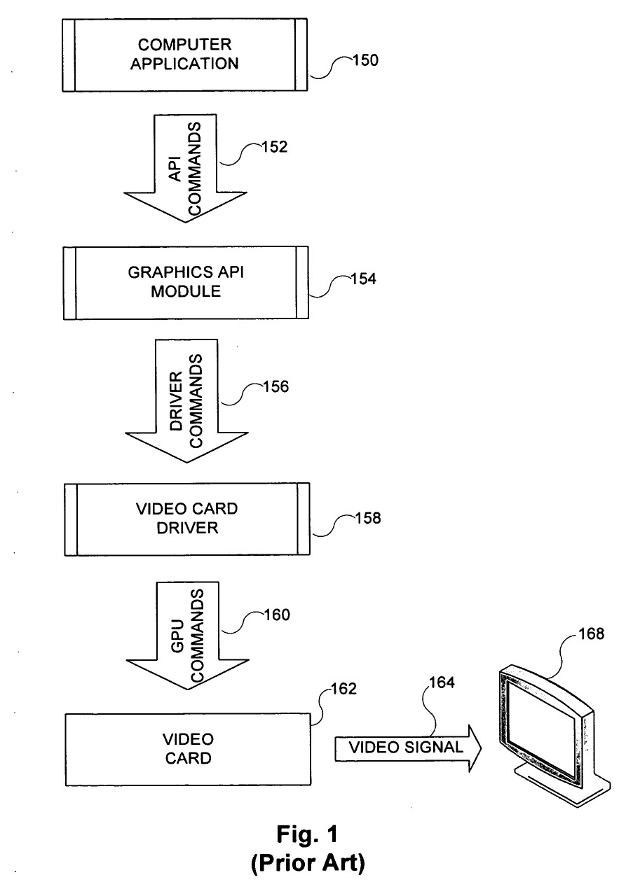

FIG. 1 is a block diagram illustrating a modern-day graphics subsystem within a computer typically configured without the present invention, and its interaction with typical personal computer software to generate an image.

Under typical circumstances, a computer application 150, such as a game, 3D graphics application or other program, will generate API commands 152 for the various graphics that it requires to be displayed on the display device 168. The API commands 152 will be issued so that they may be interpreted in accordance with one of several available APIs installed on the computer, such as DirectX or OpenGL. The appropriate API module 154 receives the API commands 152 issued by the application and will, in turn, process and transmit driver commands 156 to a video card driver 158. The video card driver 158 in turn issues GPU commands 160 to a video card 162. The video card 162 will then receive the GPU commands 160 and will, through its internal circuitry, translate the commands into a video signal 164 which is received by the display device 168 and is displayed to the user.

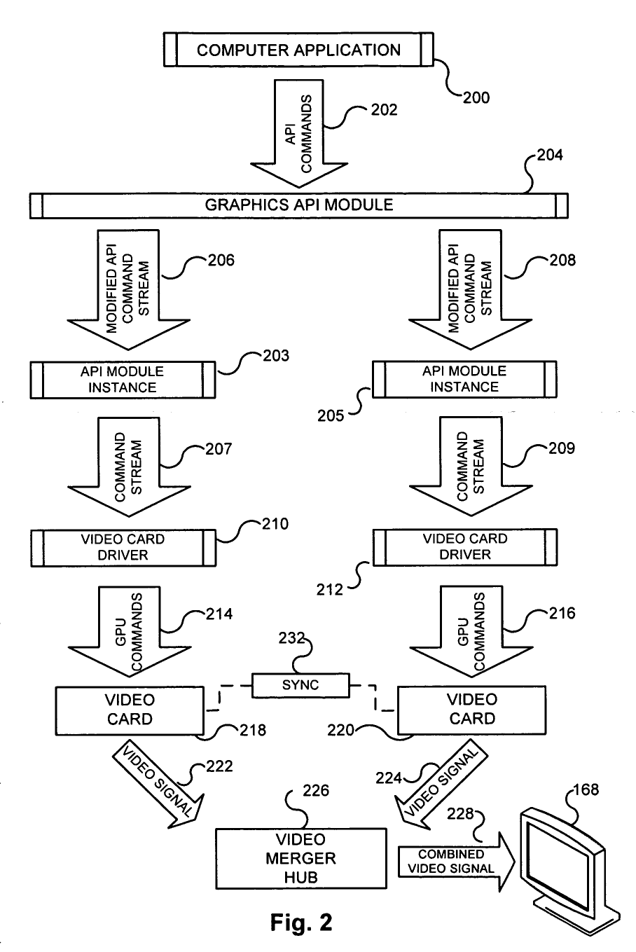

FIG. 2 is a block diagram illustrating a graphics subsystem configured in accordance with the present invention and its interaction with typical personal computer software to generate an image. For illustrative purposes only, FIG. 2 illustrates a system equipped with two video cards, each having a single GPU. However, it will be understood by those skilled in the art that additional video cards may be added to the system thereby increasing its effectiveness. Additional effectiveness may be achieved by incorporating multiple video cards, each having more than one GPU and/or by including a mix of video cards, some having single GPUs and some having multiple GPUs.

Under the present invention, the GCR module 204 is a software program that resides between the computer application and multiple instances of the API module 203,205. The GCR identifies and intercepts API commands 202 issued by the application 200 before those commands reach the API module instances 203,205. Once intercepted, the GCR module 204 generates multiple, modified API command streams 206,208. The modified API command streams 206, 208 are received by the API module instances 203,205 which in turn each generate multiple command streams 207,209 that are received and processed by their assigned video card drivers 210,212. The number of modified API command streams 206,208, and of instances of the API module 203,205, in this case two (2), is equal to the number of video cards being employed in the system. The API streams are generated in such a way that each video card will generate only the pixels that are contained within a particular region of the screen assigned to that video card.

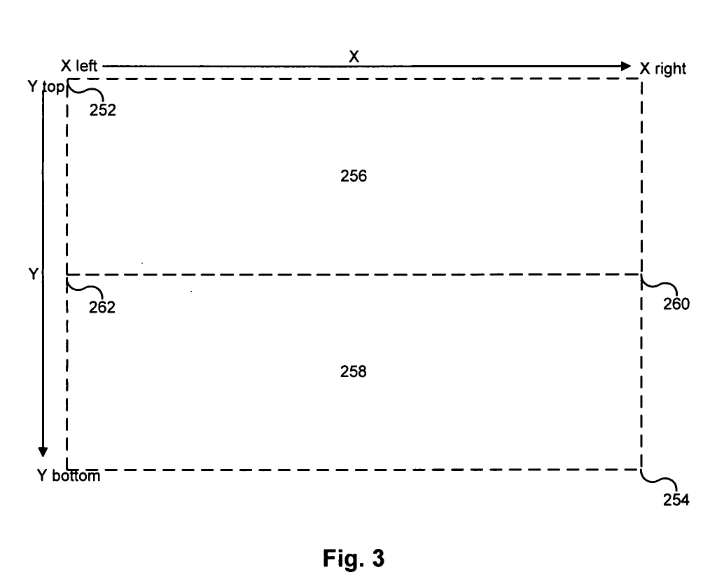

To better understand this “multiple command stream” concept, FIG. 3 illustrates how it is applied to the present invention. As shown in FIG. 3, a complete graphics screen 250 is composed of a plurality of pixels. The pixels are arranged in an X-Y grid and each pixel in the screen can be addressed using its unique X, Y coordinate. The range of coordinates for the entire screen extends from X_{left}, Yₜₒₚ for the upper left corner 252 to X_{right}, Y_{bottom} for the lower right corner 254 of the display. If, by way of the most simple example, the present invention were applied using two video cards, the screen could be divided into an upper half 256 and a lower half 258. The pixel coordinates for the upper half of the screen would range from X_{left}, Yₜₒₚ(252) to X_{right}, Y_{half}(260), and the pixel coordinates for the lower half of the screen would range from X_{left}, Y_{half}(262) and X_{right}, Y_{bottom}(254).

Accordingly, and returning to FIG. 2, the command stream 207 corresponding to the video card 218 assigned to draw the upper part of the screen could instruct the video card to process and draw only those pixels which are within the rectangle bound by coordinates X_{left}, Yₜₒₚ (252) and X_{right}, Y_{half}(260). Similarly, the command stream 209 corresponding to the video card 220 assigned to draw the lower part of the screen would instruct the video card to process and draw only those pixels which are within the rectangle bound by coordinates X_{right}, Y_{half}(262) and X_{right}, Y_{bottom}(254).

The “multiple command stream” modification can be accomplished through a variety of techniques well known in the art, a detailed discussion of which is beyond the scope of this patent. By way of example, one way used to generate the multiple command streams is to insert into each stream a unique “2D Clipping” or “3D Clipping” command which instructs the video card assigned to the stream to “draw” only those pixels which are contained within a particular rectangular contiguous region of the screen assigned to that card. For example, in a two card system where a first card is assigned the top part of the screen and a second card the bottom part, the stream corresponding to the first card would receive the video stream for the entire screen, but would also receive a 2D or 3D clipping command instructing it to “clip” (i.e., not draw) any pixels which are not within the top part of the screen. Conversely, the second card would also receive the video stream for the entire screen, but would receive a 2D or 3D clipping command instructing it to “clip” any pixels which are not within the bottom part of the screen.

The GCR 204 can also dynamically modify the various command streams so that each video card receives video commands pertaining only to a particular portion of the screen. In simple terms, each video card does not receive the entire command stream necessary to paint the entire image. For example, in a two video card system with each card being responsible for fifty percent of the screen (i.e., top/bottom), the GCR 204 would receive, interpret and process the API commands 202 from the computer application 200 and issue two sets of modified API command streams 206,208. The “top portion” video card would receive the commands required to draw only those pixels relevant to the top portion of the video screen. The “bottom portion” video card would receive the commands required to draw only those pixels relevant to the bottom portion of the video screen.

It will be understood by those skilled in the art that the different portions of the screen assigned to each video card need not be equal in size, nor must each card be assigned a contiguous portion of the video screen. Under most, but not all circumstances, it will be desirable to ensure that every portion of the screen be accounted for and assigned to a video card. However, situations can easily be envisioned where regions of the screen remain graphically static throughout and thus the graphics throughput would be increased if such regions were drawn once and then left unassigned.

Continuing with FIG. 2, each of the command streams 207,209 is then processed by its assigned video card driver 210,212 which in turn issues GPU commands 214,216 to a respective video card 218,220. Each video card 218,220 generates a video signal 222,224 corresponding to its respective portion of the screen. The multiple video signals 222,224 generated by the various video cards are sent to a video merger hub (VMH) 226 which combines them into a single output video signal 228 that is received by the display device 168.

Each video card 218,220 generally includes one or more GPUs configured to perform various rendering functions in response to instructions (commands) received via a system bus. In some embodiments, the rendering functions correspond to various steps in a graphics processing pipeline by which geometry data describing a scene is transformed to pixel data for displaying on display device 168. These functions can include, for example, lighting transformations, coordinate transformations, scan-conversion of geometric primitives to rasterized data, shading computations, shadow rendering, texture blending, and so on. Numerous implementations of rendering functions are known in the art and may be implemented by the GPUs on the video cards 218,220. Each GPU on the video cards 218,220 has an associated graphics memory which may be implemented using one or more integrated-circuit memory devices of generally conventional design. The graphics memories may contain various physical or logical subdivisions, such as display buffers and command buffers. The display buffers store pixel data for an image (or for a part of an image) that is read and transmitted to the display device 168 for display. As described above, this pixel data may be generated from scene data generated by application 150. In some embodiments, the display buffers can be double buffered so that while data for a first image is being read for display from a front buffer, data for a second image can be written to a back buffer without affecting the currently displayed image. The command buffers on the on the video cards 218,220 are used to queue commands for execution by respective on the video cards 218,220, as described below. Other portions of graphics memories on the on the video cards 218,220 may be used to store data required by the respective GPUs (such as texture data, color lookup tables, etc.), executable program code, and so on. For each graphics memory on the video cards 218,220, a memory interface may also be provided for controlling access to the respective graphics memory. The memory interfaces can be integrated with the respective GPUs or memories, or the memory interfaces can be implemented as separate integrated circuit devices. In one known implementation, all memory access requests originating from the GPU are sent to the memory interface. If the target address of the request corresponds to a location in the GPU memory, the memory interface may access the appropriate location.

A synchronizer 232 ensures that the multiple video cards are synchronized to generate video data for the same video output at the same time. There are multiple methods known to those skilled in the art for achieving this type of synchronization, but a detailed discussion of which is beyond the scope of this patent. By way of example, one way to achieve synchronization is by using a genlock (short for generator locking) mechanism. A genlock mechanism, generally speaking, synchronizes multiple devices to a specific timing signal. Another method for achieving synchronization between the multiple video cards is to designate the timing regulating device in one of the video cards as a master timing regulating device and modify the circuit in the other cards so that the timing regulating devices in those cards act as slaves of the master timing regulating devices. The timing regulating devices generally utilize piezoelectric crystals programmable crystals, oscillators or programmable oscillators as timing reference sources. Using this method, slave cards would be periodically reset by the master crystal so that their timing would be substantially synchronized during the operation of the system.

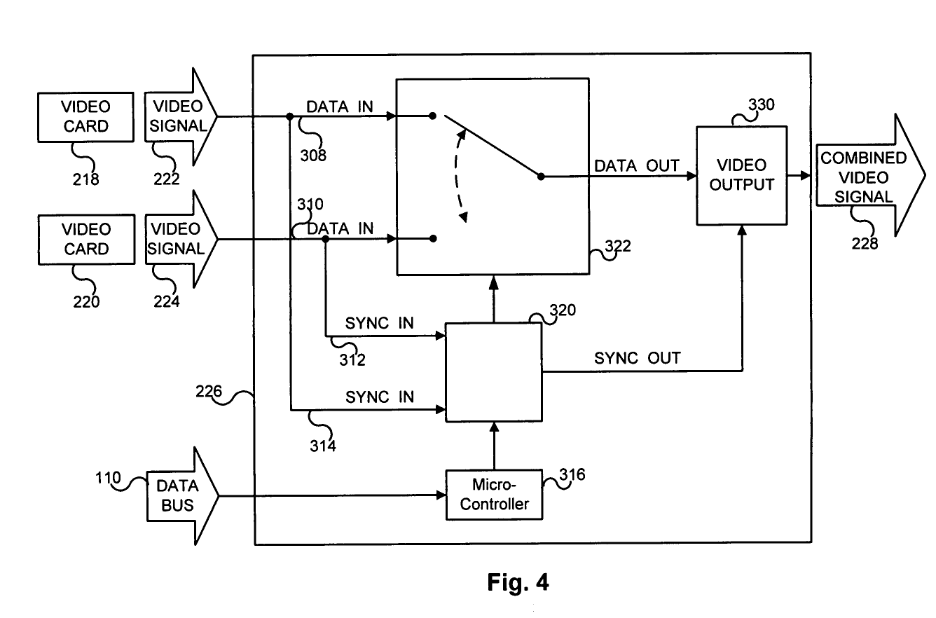

FIG. 4 shows a schematic representation detailing the operation of the VMH 226. The principal components of the VMH 226 are a video switch 322, a video switch controller 320, a microcontroller 316, and a video output 330. Typically, each video signal received by the VMH 226 is composed of a video data component 308,310 and a synchronization component 312,314. The video data component 308,310 is comprised of red, green and blue (“RGB”) (or some other representation of pixel colors) values for the pixel that is being drawn at a particular time. The synchronization component 312,314 is comprised of vertical and horizontal synchronization signals (V_{synch} and H_{synch}) which determine the vertical and horizontal position (i.e., coordinates) of the pixel that is being drawn at a particular time. Because the outputs from the video cards are synchronized (as described above) the synchronization components 312,314 from the various video signals 222,224 are substantially identical at all times.

As the video signals 222,224 arrive at the VMH 226, their video data components 308,310 are routed to the video switch 322. The video switch 322 is, in turn, controlled by the video switch controller 320 which receives the synchronization components 312,314. During each screen refresh cycle, the video switch 322 intelligently and sequentially routes the video data component from the various video signals 222,224 in such a manner that a single, seamless combined video signal 228 is then transferred from the video output 330 of the VMH 226 to the display device 168 along with the synchronization components 312,314 which essentially “pass through” the video switch controller 320.

As stated above, the video switch cycles through its multiple inputs sequentially, producing a single seamless output. The timing of the switching from one video signal to the next is critical and must be done at precisely the correct moment to make the combined video signal 228 appear seamless. In a two video card system such as the one previously used as an example in FIG. 2, at the beginning of the screen refresh cycle, the video data components from the video card 218 assigned to draw the upper half of the screen 256 are routed to the video output 330 of the VMH 226 by the video switch. Then, exactly at the point where the lower half of the screen begins to be drawn by the second video card 220, the video switch 322 is activated, or “triggered”, and the video output 330 then begins to receive the video data components from the video card 220 assigned to draw the lower half of the screen 258. As the bottom half of the screen is completed, the screen refresh cycle begins anew, the video switch 322 is again triggered, and the video output 330 again begins to receive video data from the “top portion” video card 218. This cycle is continuously repeated to achieve a seamless combined video signal 228.

The video switch 322 is controlled by the video switch controller 320 which determines how long of an interval there should be between video switch “triggers”. The controller 320 determines the triggering interval using three data elements. The first data element is the vertical refresh rate at which the video cards are operating. Vertical refresh rate is expressed in Hertz (Hz) or cycles per second. For example, a video card operating at a vertical refresh rate of 50 Hz redraws the entire screen 50 times every second. Put differently, a video card operating at 50 Hz draws a complete screen in 20 milliseconds. The video switch controller 320 dynamically calculates the vertical refresh rate from the V_{synch} part of the synchronization component 312,314 it receives from the multiple video card signals 222,224.

The second data element is the vertical resolution. One way to determine the vertical resolution is to count the number of horizontal sync pulses per frame (frame duration is calculated based on the refresh rate). For example, a video card operating at a vertical resolution of 1600×1200 has a vertical resolution of 1200 scanlines. This means that in every frame there are 1200 scanlines of video data.

The third data element used by the video switch controller 320 is the percentage of the screen which is assigned to each video card 218,220. In certain situations, it may be desirable to equally divide the screen between the video cards. In other situations, such as when one video card is more powerful than the other(s), it may be desirable to assign a greater proportion to the screen to one or more of the video cards. This element, termed the “load balancing ratio”, is assigned through software and, optionally, through user input, and is obtained by the microcontroller 316 from the computer's data bus 110. The load balancing ratio is, in turn, obtained by the video switch controller 320 from the VMH microcontroller 316.

Those skilled in the art will recognize that using a simple test feedback loop program which dynamically adjusts the load balancing ratio based on the load of each of the video cards, on a dynamic or frame by fame basis, can maximize the throughput of the combined GPUs. Typically, the test feedback loop program interacts between the GCR module 204 that divides the graphics processing assignments into separate API command streams 207, 209 and the VMH 226 that merges the resulting processed video signals 222, 224 from the video cards 218, 220. Specifically, the feedback loop program may monitor the relative processing capability of each of the video cards and dynamically resize the assigned screen portion assigned to each of the video cards as needed to maximize overall video processing throughput.

Once the vertical refresh rate, vertical resolution and the load balancing ratio are known to the video switch controller 320, it can easily calculate the triggering intervals to be used to generate the combined video signal 228. By way of illustration, in a two video card system operating at 50 Hz (i.e., 20 milliseconds to draw an entire screen) with a vertical resolution of 1200 and in which the video cards assigned to draw the upper and lower halves of the screen were respectively allocated a 25% and 75% load balancing ratio, the switching sequence would be as follows: (1) at the beginning of the screen refresh cycle, the video switch 322 would direct the video data components 308 from the upper portion video card 218 to the video output 330 of the VMH 226; (2) after 300 scanlines (25% of 1200 scanlines) the switch would be triggered by the controller 320 and would begin directing video data components 310 from the lower portion video card 220 to the video output 330 of the VMH 226; (3) after an additional 900 scanlines (75% of 1200 scanlines) the video switch 322 would be triggered to its original position to begin a new screen refresh cycle. To avoid introducing any artifacts into the end image, all switches between the various video cards are timed to occur during the horizontal blanking period of the video signals.

Thus, it can be seen that embodiments of the present invention provides multiple GPUs on a single video card or multiple video cards 218, 220 operating concurrently to share video processing duties and specifically discloses the dividing of a display area 250 into two or more discrete areas 256, 258 with one of the video cards 218, 220 is dedicated to processing for each of the discrete areas 256, 258, such as a number of lines of a raster-based display. The image is displayed by reading out the pixel data from a display buffer for each GPU or video card in an appropriate sequence. To preserve internal consistency of the displayed image (“frame coherence”), each GPU is prevented from rendering a subsequent frame until the other GPU has also finished the current frame so that both portions of the displayed image are updated in the same scanout pass.

While the above discussion describes of the present invention discloses the display area being divided into two separate areas 256, 258, it should be appreciated that the display area 250 may be divided using different techniques and the two or more video cards 218, 220 operate concurrently to share video processing duties by handling different areas. For instance, the display area 250 may be divided into four areas, with each of the video cards 218, 220 handling two separate sections, or with one of the video cards 218, 220 handling three of the four display areas as needed for load balancing. Likewise, it is possible, to pair the video cards 218, 220 by having each handle, respectively, odd and even display rows, such as used in an interlaced display where the projected image alternates rapidly between the even-numbered lines and the odd-numbered lines of each picture. For example, in standard over-the-air television broadcasting, only half the lines from each frame are transmitted in what is known as a field, with one field (the odd field) containing only the odd-numbered lines and the next (the even field).containing only even-numbered lines.

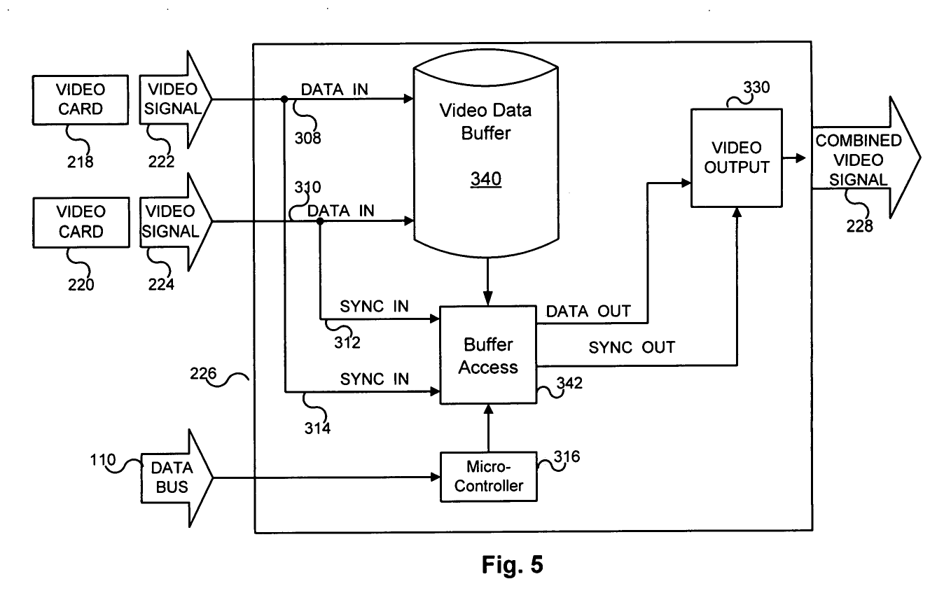

In the above described embodiments of the present invention, it can be seen that that the VMH 226 takes and combines concurrent video signal output 222, 224 from multiple GPUs or video cards 218, 220 and organizes the disjoint video data 308, 310 into a coherent video output 330 using synch data 312, 314 to control the operation of the switch 322 that selectively accepts the video data 308, 310 to derive the video output 330. Referring now to FIG. 5, in an alternative embodiment of the present invention, the VMH 226 further comprises a video buffer 340 that receives and stores the disjoint video data 308,310. Specifically, the video buffer 340 stores the unordered video data video data 308, 310 as received from the video cards 218, 220. A buffer access application 342 then selectively accesses the video memory buffer, according the synch data 312, 314 as needed to form the coherent video output 330. Specifically, during each screen refresh cycle, the buffer access application 342 intelligently accesses the video buffer 340 containing the video data component 308, 310 such that a single, seamless combined video signal 228 is then transferred from the video output 330 of the VMH 226 to the display device 168 along with the synchronization components 312,314 which essentially “pass through” the buffer access application 342.

Alternatively, the video buffer 340 may store the video data component 308, 310 according to the synch data 312, 314 in an ordered form, such that during each screen refresh cycle, the buffer access application 342 can merely access already ordered video data component 308, 310 as needed to form the composite video output 330 combining the various display regions processed by each of the video cards 218, 220.

It should be appreciated that other methods for organizing video data to a display may be used the present invention, where each of the video cards 218, 220 is responsible for a separate portions of the stream of the video data instead of a separate portion of the display area 250. For example, the two video cards 218, 220 may cooperate to provide video data to a display by taking turns, with the first video card 218 controlling the display for a certain time period and having the second video 220 sequentially assuming video processing duties at the end of that period. This configuration provides advantages in that one video card 218 may provide processed video data while the second video 220 is completing its processing of the next video data for the next time period.

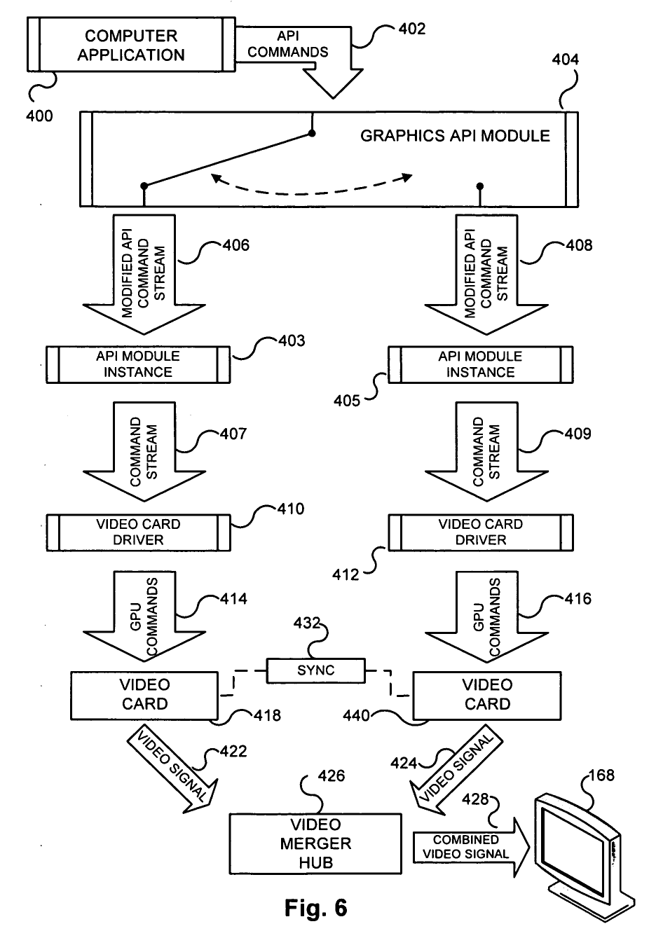

Referring now to FIG. 6, the processing of a video signal by multiple GPUs or video cards through time division is disclosed in greater detail. FIG. 6 is a block diagram illustrating a graphics subsystem configured in accordance with the present invention and its interaction with typical personal computer software to generate an image using multiple video cards or multiple GPUs located on a single card. For illustrative purposes only, FIG. 6 illustrates a system equipped with two video cards 418, 420, each having a single GPU. However, it will be understood by those skilled in the art that additional video cards or cards having multiple independent GPUs may be added to the system, thereby increasing its effectiveness. Likewise, additional effectiveness may be achieved by incorporating multiple video cards, each having more than one GPU and/or by including a mix of video cards, some having single GPUs and some having multiple GPUs.

In the present invention, the graphics module 404 is a software program that resides between the computer application and multiple instances of the API modules 403,405. The GCR identifies and intercepts API commands 402 issued by an application 400. Once intercepted, the GCR module 404 generates multiple, modified API command streams 406,408, generally by operating some type of signal switch that selectively routes the API commands 402 between the API modules 403,405 according to various criteria such as a time stamp associated with the API commands 402. The modified API command streams 406, 408, each representing discrete portions of the API commands 402, are received by API modules instances 403,405 which, in turn, generate, respectively, command streams 407,409, which are received and processed by their respective assigned video card driver 410,414. The number of modified API command streams 406,408 and the API modules 403,405, in this case two (2), is generally equal to the number of video cards or GPUs being employed in the system. The command streams 406,408 are generated in such a way that each video card 418, 420 generates the pixels that are contained within the display screen during time periods assigned to that respective video card. The time division of an API command stream 402 into multiple separate command streams can be accomplished through a variety of techniques well known in the art, a detailed discussion of which is beyond the scope of this patent.

As suggested above, the graphics module 404 can dynamically allocate the various command streams so that each video card receives video commands pertaining only to particular time brackets of the display. In simple terms, each video card 418, 420 receives the entire command stream necessary to paint the entire image during discrete time periods. For example, in a two video card system with each card being responsible for fifty percent of the discrete time periods, such as odd and even time periods, the graphics module 404 would receive, interpret and process the API commands 402 from the computer application 400 and issue two sets of modified API command streams 406,408. The “odd period” video card would receive the commands required to draw only those pixels relevant to the odd periods (periods 1, 3, 5, etc.) of the video screen display. The “even period” video card would receive the commands required to draw only those pixels relevant to the even periods (periods 2, 4, 6, etc.) of the video screen display. It will be understood by those skilled in the art that the different time periods of the screen display assigned to each video card need not be equal in size, nor must each card be assigned a contiguous time period of the video display.

Each of the command streams 407,409 is then processed by its assigned video card driver 410,414, which in turn issues GPU commands 414,416 to a respective video card 418,420. Each video card 418,420 in turn generates a video signal 422,424 corresponding to its respective time periods for managing the output of the video display screen 168.

A synchronizer 434 ensures that the multiple video cards 418, 420 are coordinated to generate video data that integrates to form a visual display 168 that seamlessly presents the video data from different time periods. There are multiple methods known to those skilled in the art for achieving this type of synchronization, but a detailed discussion of which is beyond the scope of this patent. By way of example, one way to achieve synchronization is by using a genlock (short for generator locking) mechanism. A genlock mechanism, generally speaking, synchronizes multiple devices to a specific timing signal. Another method for achieving synchronization between the multiple video cards is to designate the timing regulating device in one of the video cards as a master timing regulating device and modify the circuit in the other cards so that the timing regulating devices in those cards act as slaves of the master timing regulating devices. The timing regulating devices generally utilize piezoelectric crystals programmable crystals, oscillators or programmable oscillators as timing reference sources. Using this method, timing crystals in slave cards would be periodically reset by the master crystal so that their timing would be substantially synchronized during the operation of the system. In this way, one of the video cards may produce a synchronizing signal that directs the operation of the remaining video cards, such that any timing irregularities is promptly compensated in subsequent calculations.

The multiple video signals 444,444 generated by the various video cards are sent to a video merger hub (VMH) 426 that combines them into a single output video signal 428 that is received by the display device 168.

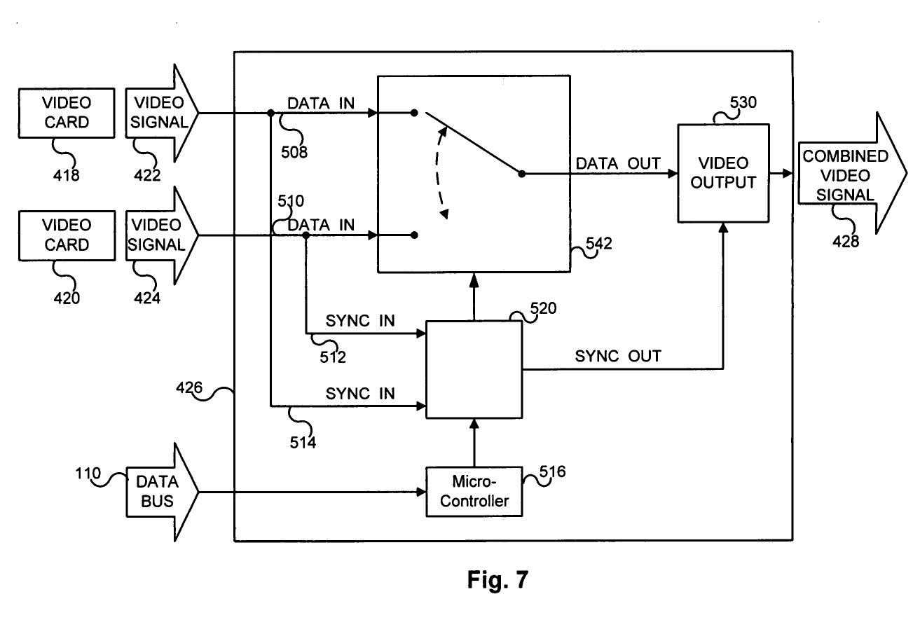

FIG. 7 shows a schematic representation detailing the operation of the VMH 426 in one embodiment of the present invention. The principal components of the VMH 426 are a video switch 522, a video switch controller 520, a microcontroller 516, and a video output 530. Typically, each video signal received by the VMH 426 is composed of a video data component 508, 510 and a synchronization component 512, 514. The video data component 508, 510 is comprised of red, green and blue (“RGB”) (or some other representation of pixel colors) values for pixels being drawn at a particular time. The synchronization component 512, 514 is comprised of time synchronization signals (T_{synch}) which determine the particular times of the pixels associated with the video data components 508, 510.

As the video signals 422, 424 arrive at the VMH 426, their video data components 508, 510 are routed to the video switch 522. The video switch 522 is, in turn, controlled by the video switch controller 520 which receives the synchronization components 512, 514. The video switch 522 intelligently and sequentially routes the video data component from the various video signals 422, 424 in such a manner that a single, seamless combined video signal 428 is then transferred from the video output 530 of the VMH 426 to the display device 168 along with the synchronization components 512, 514 which essentially “ass through the video switch controller 520.

As stated above, the video switch 522 cycles through its multiple inputs sequentially, producing a single seamless output. The timing of the switching from one video signal to the next at a correct moment makes the combined video signal 428 appear seamless; i.e., the display 168 does not receive different instructions concurrently, and there is no pause between the end of one video data stream and the beginning of the next video data stream. In a two video card system such as the one previously used as an example in FIG. 6, the video data components from the video card 418 assigned to draw the screen during a certain time period are routed to the video output 530 of the VMH 426 by the video switch 422 during the appropriate time period as indicated by the synch data. Then, at the point the time period for the first video card 418 ends and time period for the second video card 420 begins, the video switch 522 is activated, and the video output 530 then begins to receive the video data components from the other video card 420. As the time period for the second video card 420 is completed, the cycle begins anew, with the video switch 522 again operating so that the video output 530 now receives video data from the first period video card 418. This cycle is continuously repeated to achieve a seamless combined video signal 428.

The video switch 522 is controlled by the video switch controller 520, which determines how long of an interval there should be between video switch triggers. The controller 520 determines the triggering interval using the synchronization component 512, 514 received within the multiple video card signals 422, 424. The primary element used by the video switch controller 520 is the duration of the time periods assigned to each video card 418,420. In certain situations it may be desirable to equally divide the time periods between the video cards. In other situations, such as when one video card is more powerful than the other(s) or possesses a relatively greater bandwidth connection, it may be desirable to assign a longer time period to one of the video cards. This load balancing ratio is assigned through software and, optionally, through user input, and is obtained by a microcontroller 516 from the computer's data bus 110. The load-balancing ratio is, in turn, obtained by the video switch controller 520 from the microcontroller 516.

Those skilled in the art will recognize that using a simple test feedback loop program which dynamically adjusts the load balancing ratio based on the load of each of the video cards, on a dynamic or period-by-period basis, can maximize the throughput of the combined GPUs. Typically, the test feedback loop program interacts between the graphics module 404 that divides the graphics processing assignments into separate API command streams 407, 409 and the VMH 426 that merges the resulting processed video signals 422, 424 from the video cards 418, 420. Specifically, the feedback loop program may monitor the relative available processing capability of each of the video cards 418, 420 and dynamically resize the length of the time periods assigned to each of the video cards 418, 420 as needed to maximize overall video processing throughput by minimizing the idleness of the video cards 418, 420.

Thus, it can be seen that embodiments of the present invention provides multiple GPUs on a single video card or multiple video cards 418, 420 operating concurrently to share video processing duties and specifically discloses the dividing of time period of the display area 450 into two or more discrete time periods, where each of the video cards 418, 420 is specifically dedicated to processing separate time periods. The image is displayed by reading out the pixel data from a display buffer for each GPU or video card in an appropriate sequence. To preserve internal consistency of the displayed image, each GPU is prevented from rendering a subsequent display until the other GPU has finished the current display.

It is possible, to pair the video cards 418, 420 by having each handle, respectively, odd and even display rows, such as used in an interlaced display where the projected image alternates rapidly between the even-numbered lines and the odd-numbered lines of each picture. For example, in standard over-the-air television broadcasting, only half the lines from each frame are transmitted in what is known as a field, with one field (the odd field) containing only the odd-numbered lines and the next (the even field) containing only even-numbered lines.

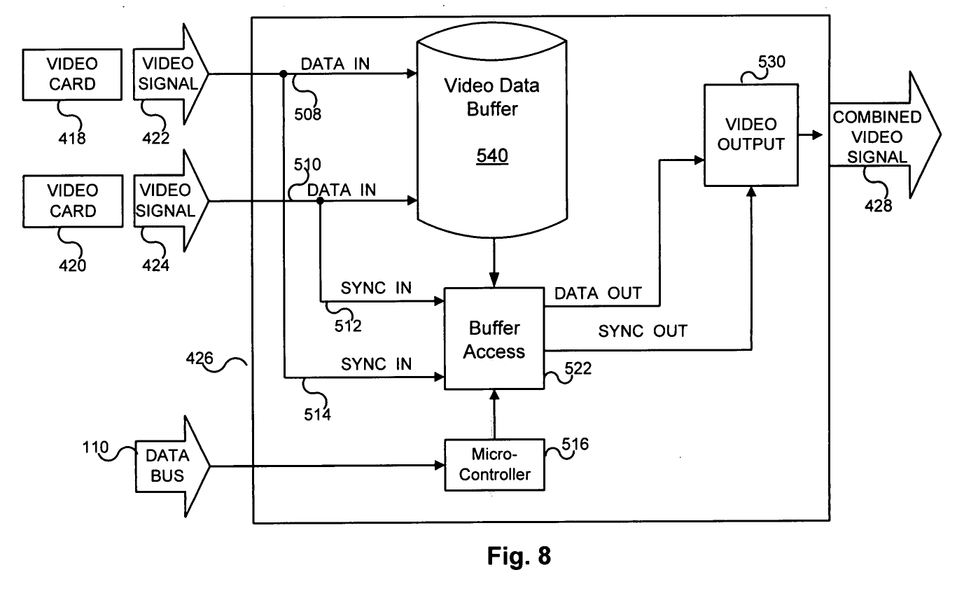

Referring now to FIG. 8, in an alternative embodiment of the present invention, the VMH 426 further comprises a video buffer 540 that receives and stores the disjoint video data 508, 510. The video buffer 540 stores the unordered video data video data 508, 510 as received from the video cards 418, 420. A buffer access application 542 then selectively accesses the video memory buffer, according the synch data 512, 514 as needed to form the video output 530 during the time periods associated with each of the video cards 418, 420. For example, it should be appreciated that each of the video cards 418, 420 is concurrently streaming processed video data for different time periods. The buffer 540 may store this data, as received, in a disorganized condition, with this data being selectively accessed according to the synch data 512, 514 as needed to produce an ordered video data stream. Specifically, during each of the assigned periods, the buffer access application 542 intelligently accesses the video buffer 540 containing the video data component 508, 510 from the various video signals 422, 424 in such a manner that a single, seamless combined video signal 428 is then transferred from the video output 530 of the VMH 426 to the display device 168.

Alternatively, the video buffer 540 may store the video data component 508, 510 in an ordered form using the synch data 512, 514, such that the buffer access application 542 can merely access already ordered video data component 508, 510 without further processing as needed to form the sequential video outputs 530 combining the various time periods processed by each of the video cards 418, 420.

Accordingly, it will be understood that the preferred embodiment of the present invention has been disclosed by way of example and that other modifications and alterations may occur to those skilled in the art without departing from the scope and spirit of the appended claims.

1. An accelerated graphics processing system comprising:
a graphics API module receiving commands from a computer application, wherein said graphics API module divides said commands into a plurality API commands comprising first API commands related to a first time period, and second API commands related to a second time period;
a plurality of graphics processing units (GPUs) adapted to receive said first and second API commands from the graphics API module, wherein the plurality of GPUs comprise a first GPU and a second GPU, wherein the first GPU receives the first API commands and the second GPU receives the second API commands, wherein the first GPU processes the first API commands to produce a first video signal comprising first video data related to the first time period and first synch data associating said first video data to said first time period, and wherein second GPU processes the second API commands to produce a second video signal comprising second video data related to the second time period and second synch data associating said second video data to said second time period; and
a video merger hub adapted to receive said first and said second video signals from said plurality of GPUs, wherein said video merger hub analyzes said first and said second synch data and forwards to a display device said first video data during said first time period and said second video data during said second time period.

2. The accelerated graphics processing system of claim 1, wherein said first GPU is located on a first video card and said second GPU is located on a second video card, wherein said first and said first video cards are coupled to a computer.

3. The accelerated graphics processing system of claim 1, wherein said video merger hub comprises a video switch; a video switch controller; a microcontroller; and a video output.

4. The accelerated graphics processing system of claim 3, wherein said video switch receives said first video data and said second video data from said plurality of GPUs and sequentially routes said first video data and said second video data to said video output.

5. The accelerated graphics processing system of claim 4, wherein said video switch is controlled by said video switch controller, and wherein said video switch controller controls said video switch by triggering routing switches at appropriate intervals corresponding to said first and said second time periods.

6. The accelerated graphics processing subsystem of claim 1, wherein said first and said second time periods are defined by a load balancing ratio, wherein said load balancing ratio is dynamically adjusted by a test feedback loop program which measures a processing load on each of said GPUs.

7. A method for load balancing for a plurality of graphics processors configured to operate in parallel, the method comprising: providing a display area comprising a sequence of frames comprising N frames, the N frames comprising K frames to be rendered by a first one of the plurality of graphics processors and a remaining N-K frames to be rendered by a second one of the plurality of graphics processors, wherein a ratio of K/(N-K) is a load balancing ratio of the first and second graphics processor; instructing the plurality of graphics processors to render the frames, wherein the first and second graphics processors perform rendering, respectively, of the K frames and the N-K frames; receiving feedback data for the frames from the first and second graphics processors, the feedback data reflecting respective rendering times for the first and second graphics processors; determining, based on the feedback data, whether an imbalance exists between respective loads of the first and second graphics processors; and in the event that an imbalance exists: identifying, based on the feedback data, which of the first and second graphics processors is more heavily loaded, and decreasing a number of frames that is rendered by the more heavily loaded one of the first and second graphics processors by selecting a new value for K to adjust the load balancing ratio.

8. The method of claim 7, wherein the step of decreasing a number of frames that is rendered by the more heavily loaded one of the first and second graphics processors further includes selecting a new value for N to adjust the load balancing ratio.

9. The method of claim 7, wherein the step of receiving the feedback data includes receiving the feedback data for each of a plurality of frames.

10. The method of claim 7, further comprising: generating a command stream for each of the first and second graphics processors, the command stream including a set of rendering commands for the frames; and inserting a write notifier command into a command stream for each of the first and second graphics processors following the set of rendering commands, wherein each of the first and second graphics processors responds to the write notifier command by transmitting the feedback data to a storage location.

11. The method of claim 7, wherein each of the N frames is alternatively rendered by each of the first and second graphics processors.

12. A graphics processing system comprising: a graphics driver module; and a plurality of graphics processors configured to operate in parallel to render respective sets of frames in a sequence of frames and to provide feedback data to the graphics driver module, the graphics driver module being further configured to detect, based on the feedback data, an imbalance between respective loads of two of the plurality of graphics processors and, in response to detecting an imbalance, to decrease a size of a first set of frames that is rendered by a more heavily loaded one of the two graphics processors and to increase a size of a second set of frames that is rendered by the other one of the two graphics processors.

13. The graphics processing system of claim 12, further comprising a plurality of graphics memories, each graphics memory coupled to a respective one of the graphics processors and storing pixel data for frames rendered by the graphics processor coupled thereto.

14. The graphics processing system of claim 12, wherein the graphics driver module is further configured to generate a command stream for the plurality of graphics processors, the command stream including a set of rendering commands for frames and an instruction to each of the two graphics processors to transmit feedback data indicating that the transmitting processor has executed the set of rendering commands.

15. The graphics processing system of claim 12, wherein the feedback data includes an indication of which of the two graphics processors was last to finish rendering the respective set of frames.

16. The graphics processing system of claim 15, wherein the feedback data includes a numeric identifier of the one of the two graphics processors that was last to finish, and the graphics driver module is further configured to compute a load coefficient from the numeric identifiers over a plurality of frames.

17. The graphics processing system of claim 16, wherein the graphics driver module is further configured to detect an imbalance in the event that the load coefficient is greater than a high threshold or less than a low threshold.
